(19) United States
(12) Patent Application Publication
(10) Pub. No.: US 2022/0259030 A1
(43) Pub. Date: Aug. 18, 2022

(54) GRIPPING AND CLOSING DEVICE FOR A KEG TYPE CONTAINER

(71) Applicant: Emanuela Covi, Merano (IT)

(72) Inventor: Emanuela Covi, Merano (IT)

(21) Appl. No.: 17/623,080

(22) PCT Filed: Aug. 13, 2020
(86) PCT No.: PCT/IT2020/050205

§ 371 Date: Dec. 27, 2021

(30) Foreign Application Priority Data
Aug. 14, 2019 (IT) 102019000014799

(51) Int. Cl. B67D 1/08; B65D 25/28

(52) U.S. Cl. CPC B67D 1/0835; B65D 25/28

(57) ABSTRACT

The invention concerns a gripping and closing device for a keg-type container (10) for liquids, said gripping and closing device comprising a closing and tapping cap (16) and a gripping handwheel (15) which is suitable to handle and move the container (10), said container (10) comprising a drum (13) containing a bag and being able to cooperate with said closing cap (16), said closing cap (16) being suitable to selectively close an entrance (25) of the container (10) allowing the tapping. The invention also concerns a container (10) for liquids comprising the gripping and closing device (11), a method to assemble a gripping and closing device (11) and a method to assemble a container (10) for liquids comprising the method to assemble a gripping and closing device (11). The invention also concerns a combination of a gripping and closing device (11) and of a bottom element (14) suitable to support a drum (13) in a vertical direction and reciprocally stackable with a gripping and closing device (11) of another container (10).

### FIELD OF THE INVENTION

Embodiments described here concern a gripping and closing device for a container for liquids, also called “keg”, suitable to contain beverages or other liquids.

The liquids can be, by way of example, food liquids (such as beverages or oil or others) or other liquids, either fluid or dense, having for example different applications, said different applications being in the field of hygiene, medicine, pharmaceuticals, health and/or hospitals or other.

The containers can be made, more specifically, of metal or plastic material; the present invention concerns containers made of plastic material.

The container in question is, preferably but not only, suitable to contain a wide range of liquids that in contact with the air would be damaged more or less seriously, and at worst become unusable.

The present invention also concerns the container for liquids associated with the gripping and closing device, advantageously though not exclusively, comprising an external container or drum, for containing and protection purposes, which in turn contains an internal container or bag, to contain the liquid.

The present invention also concerns a bottom base for a container, suitable to be possibly positioned above the gripping and closing device to allow the containers to be stacked.

Embodiments described here also concern a method to assemble the gripping and closing device and a method to assemble the container for liquids.

### BACKGROUND OF THE INVENTION

In the state of the art, containers for liquids are known, comprising two coaxial elements, which constitute an external container, or drum, with a function of support and protection, and an internal container, or bag, with the function of containing the liquid.

It is known that between the drum and the bag, when the bag is full of liquid, an interspace can be generated due to the effect of a fluid under pressure which, compressing the bag, causes the liquid to leak.

The liquid left in the bag is always isolated from the air, and is therefore not subject to oxidation or to the entry of foreign bodies, or contaminants, which can for example also be pathogenic.

For delivery operations, a specific valve unit is usually provided in the upper part in the mouth of the container, constrained to, or by, a cap or closing device, on which means for delivering the liquid can be attached for the time envisaged for all the liquid contained in the bag to be used up.

The valve unit is configured both for the introduction of the pressurized fluid into the drum and for the consequent delivery of the liquid present in the bag, which therefore must have a very reduced thickness.

Due to the way they are made, these containers usually have curved surfaces.

Furthermore, due to the presence of the bag inside, the drum cannot have any protrusions or recesses that could damage the bag.

It is also known that containers made of plastic material exist, the base of which is configured to allow a stable position when the container is placed vertically.

These known plastic containers cannot be stacked, nor can they be handled except by acting on the upper surface if associated with a gripping element.

In the most general and safest case for the bag, the bottom of the drum is shaped with a curved surface. It is therefore necessary to provide a bottom element that allows the drum to be supported vertically, when resting on the ground, and allows it to be stacked if the upper part is equipped for the purpose.

Furthermore, since these containers can be of various sizes, even to contain 30 or more liters of liquid, they can be unwieldy for a user, especially when they are full.

Generally, in order to allow the containers to be moved in a practical way, it is necessary at least to provide in association with them, either directly or indirectly, a gripping element that can be called a “handwheel”, and possibly a lower gripping element.

Finally, it is necessary to ensure that the bottom element and the gripping handwheel can cooperate with each other, to allow the drums to be stacked on top of each other during storage operations.

One disadvantage of these known solutions is that they require both particular shapes of the container to allow the coupling of the gripping handwheel, and also a plurality of assembly operations, even complex ones, to obtain the finished product.

Furthermore, they do not guarantee a stable and safe coupling of the gripping handwheel and the container, in particular when the container is completely full.

Another disadvantage of known solutions is that they are not very versatile and do not allow to adapt the gripping and closing device to containers and/or types of dispensers of different types.

Another disadvantage is that the various components of the container can be made with materials, plastic or not, which are not compatible with each other, therefore the container has to be at least partly disassembled in order to be recycled through different channels.

This entails difficulties for the end user of the empty container who has to separate the various components and deliver them individually to the appropriate collection areas.

There are also additional labor costs, problems of differentiated transport, costs of differentiated storage with specific areas and with additional investment and management costs for recycling.

Document CN108033094A describes a handle for a container for beverages, in particular wine. The handle comprises a gripping portion, an internal connection portion suitable to connect to a valve for the liquid to exit, and an external connection portion to connect and rest on the container. The solution described in this document provides to couple the handle directly with the valve for the liquid to exit installed in the neck portion of the container, without providing any closing cap.

Document GB2481436 describes a gripping element for a container, which includes a gripping portion, and a central hole suitable to be positioned in correspondence with an aperture of a neck portion of the container. The coupling of the gripping element and the container occurs by means of protruding portions of the gripping element that couple with respective edges provided on the container.

The Applicant set himself the problem of how to improve the containers as above and, in particular, the closing devices for said containers.

He also set himself the problem of making everything recyclable without requiring any operation to separate the components.

In particular, one purpose of the present invention is to provide an ergonomic gripping and closing device which allows the containers to be easily moved even when they are full.

Another purpose of the present invention is to provide a gripping and closing device that is suitable to cooperate with different types of closing caps suitable for the various liquid delivery means on the market and in use, without needing to modify or adapt the solutions already available on the market.

Another purpose of the present invention is to obtain a gripping and closing device which is simple to manufacture by assembling it with the closing cap, so that the whole can be easily assembled on the container.

Another purpose of the present invention is to make available a gripping and closing device which allows to obtain a solid and reliable coupling with the container.

Another purpose of the present invention is to obtain a gripping and closing device that allows to close the container hermetically, guaranteeing the hygiene of the content both during its storage and also during delivery.

Another purpose is to make available a bottom element which allows to support the drum in the vertical direction.

Another purpose of the present invention is to provide a gripping and closing device suitable to cooperate with the bottom element to facilitate the stacking of the containers.

Another purpose of the invention is to reduce the costs of production, storage, management and assembly of the container.

Another purpose of the present invention is to provide a container, with the connected gripping and closing device, which can be recycled as a whole, thus simplifying its delivery, storage, transport and use for recycling.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, the present invention concerns a gripping and closing device for a keg-type container for liquids.

The container that can be used in association with the embodiments described here is advantageously suitable to contain food liquids or other liquids, whether fluid or dense, which for example have different applications, such applications can be linked to drinking or hygiene requirements, or other, in the domestic, commercial or industrial sector, and in the medical, pharmaceutical, health and/or hospital sectors or more.

According to some embodiments, the container for liquids of the type in question comprises, in its broadest formulation, the gripping and closing device as above, a valve unit, a drum and a bottom element.

The gripping and closing device according to the invention integrates a gripping handwheel to handle and move the container which cooperates, in a single body, directly or by stable association, with a closing and tapping cap, suitable to selectively close the entrance of the container, allowing the tapping.

The closing cap can directly and stably couple with the valve unit.

In particular, the gripping handwheel, if it cooperates with the closing cap by stable association, can comprise attachment means configured to allow a stable reciprocal association.

Advantageously, the closing cap increases the strength of the container during use, since the delivery means cooperate both with the closing cap and also with the valve unit. For example, it is not possible to exert an excessive thrust directly on the valve unit during the operations of inserting the delivery means.

It also increases the level of hygiene of the container, since the presence of the closing cap prevents foreign substances from coming into direct contact with the valve unit.

Being able to directly couple the valve unit with the closing cap allows to facilitate the actions of assembling and closing the container, since it is possible to insert the valve unit inside a neck portion of the latter directly during the step of reciprocal connection between the gripping and closing device and the container.

It is also possible to use different models of valve units, even with smaller diameters than the entrance of the container, thanks to the adaptation that the cap can provide, for example by means of adaptor elements. Advantageously, it is therefore possible to use different models of valve units present on the market.

Practicality of use is also maintained, since it is possible to install the closing cap and the handwheel in a single operation, since the cap and the handwheel are configured in a single body.

According to some embodiments, the gripping handwheel can comprise gripping handle means, which advantageously have gripping elements suitable to facilitate the grip in order to handle the container without, for example, causing damage to the user's hands.

The gripping handle means can also advantageously comprise strengthening elements that can have a double function of facilitating the grip and increasing the mechanical strength of the gripping handwheel.

It is therefore an advantage to have a gripping and closing device that allows to easily manage the container during the transport steps, allowing to easily handle the containers even when they are full.

According to some embodiments, the upper part of the gripping handle means can be positioned, when applied to the drum, at a greater height than the upper edge of the closing cap, preventing the closing cap from being damaged, for example during stacking, transport or handling.

The gripping handwheel, if in stable association with the closing cap, can advantageously have shapes suitable for various types of closing cap or even provide intermediate adaptor means specialized for the various closing caps.

For example, it can allow to use closing caps of different thicknesses, sizes or shapes, without the bottom element of the upper container resting on the closing cap of the lower container, when the containers are stacked on top of each other.

One advantage is therefore the possibility of using the same gripping handwheel, directly or by using intermediate means, with closing caps of different thicknesses, for example adaptable to the different liquid delivery means available on the market.

This allows to reduce the models of gripping handwheels, thus reducing both production and also storage and management costs.

The configuration of the gripping and closing device, according to the invention, can be such as to be used in cooperation with a bottom element of the container in order to stack the containers on top of each other, without risk of them falling and without the closing cap being damaged.

Advantageously, the bottom element can have gripping means for handling.

According to some embodiments, the gripping handwheel has a plurality of connection elements that connect the grip handle means to the attachment means or to the closing cap.

According to some embodiments, the connection elements are shaped in such a way as to be coherent with the upper profile of the drum, generating a plurality of zones for the gripping and closing device to rest, so as to obtain the most stable connection possible.

The load can, in this way, be distributed over the plurality of support zones, thus allowing to stack multiple containers on top of each other.

Advantageously, the connection elements can therefore also have a support function during storage and transport operations.

Furthermore, the connection elements, in addition to having the required strength, according to the invention have shapes that are suitable to prevent breaking points and, or also, parts that can for example cause damage to the user's hands.

According to some embodiments, the gripping and closing device has interference members configured to cooperate with mating anti-tampering elements present in the neck portion of the drum and suitable to prevent tampering when the drum and the gripping and closing device are associated in a definitive manner.

It is therefore an advantage to be able to verify whether, after the container for liquids has been assembled, the latter has been reopened, causing for example the adulteration of the liquid contained inside it, or damage to its organoleptic characteristics due to exposure to air or removal of part or all of the liquid.

Embodiments described here also concern a bottom element to support a container, possibly suitable to cooperate with the gripping and closing device to allow a reciprocal stacking of the components and therefore of the containers associated therewith.

According to some embodiments, the bottom element can have a bottom base with a shape, advantageously though not necessarily, at least partly mating with the shape of the upper surface of the gripping and closing device, advantageously achieving a same-shape coupling in order to facilitate the storage of containers.

The gripping and closing device and the bottom element can thus confer upon the container characteristics that allow to stack a desired number of containers.

Embodiments described here also concern a container for liquids comprising a drum, a valve unit, a gripping and closing device and possibly a bottom element.

Embodiments described here also concern a method to assemble a gripping and closing device by assembling the gripping handwheel with the closing cap.

Embodiments described here also concern a method to assemble all or a part of a container.

According to further embodiments, the method to assemble a container can provide to associate in correspondence with the lower end of the drum, in a stable or removable manner, a bottom element suitable to support it in the vertical direction.

### ILLUSTRATION OF THE DRAWINGS

These and other aspects, characteristics and advantages of the present invention will become apparent from the following description of some embodiments, given as a non-restrictive example with reference to the attached drawings wherein:

FIG. 1 is a three-dimensional view of two containers according to the invention stacked on top of each other with the gripping and closing device according to a first embodiment;

FIG. 2 shows a three-dimensional top view of a gripping and closing device according to variants described here, in which a valve unit is inserted;

FIG. 2a shows a three-dimensional top view of a gripping and closing device according to variants described here;

FIG. 3 shows a section front view of a coupling step between the closing cap and the gripping handwheel, in which the gripping handwheel is sectioned along a strengthening element;

FIG. 4 shows a section front view of a coupling step between the gripping and closing device and the drum according to some embodiments described here;

FIG. 5 shows a section front view of the gripping and closing device, coupled with the valve unit and screwed to a drum according to some embodiments described here;

FIG. 6 shows a three-dimensional top view of the neck portion of the drum of a container according to some embodiments described here;

FIG. 7 shows an enlarged detail in a three-dimensional top view of the gripping handwheel and the neck of the drum in which the closing cap has been removed for clarity of view;

FIG. 8 shows a section front view of a bottom element of a container stacked on a gripping and closing device according to some embodiments described here which are stacked one on top of the other, in which the gripping handwheel is sectioned along a connection element.

To facilitate comprehension, the same reference numbers have been used, where possible, to identify identical common elements in the drawings. It is understood that elements and characteristics of one embodiment can conveniently be incorporated into other embodiments without further clarifications.

### DESCRIPTION OF EMBODIMENTS

We will now refer in detail to the various embodiments of the invention, of which one or more examples are shown in the attached drawings. Each example is supplied by way of illustration of the invention and shall not be understood as a limitation thereof. For example, one or more characteristics shown or described insomuch as they are part of one embodiment can be adopted on, or in association with, other embodiments to produce another embodiment. It is understood that the present invention shall include all such modifications and variants.

With reference to the attached drawings, there is described a gripping and closing device 11 applicable to a keg-type container 10 for liquids.

The container 10 has, in its most extensive formulation, the gripping and closing device 11, a valve unit 12, a drum, or external container, 13 and possibly a bottom element 14.

The drum 13, which has a support and protection function, can contain an internal container (not shown), or bag, into which the liquid is inserted.

The container 10 can be able to cooperate with a closing and tapping cap 16, suitable to selectively close the entrance 25 of the container 10, allowing tapping.

The container 10 can be able to advantageously cooperate with a gripping handwheel 15 suitable to handle and move the container 10.

In some embodiments, the gripping and closing device 11 comprises the gripping handwheel 15 and the closing and tapping cap 16 which, when in the operative condition, are substantially conformed in a single body, obtained directly or by stable association.

In some embodiments, the gripping handwheel 15 and the closing cap 16 can cooperate with each other since they are stabilized by association in a single body, possibly with an intermediate adaptor mean not shown.

In a variant not shown, the gripping handwheel 15 and the closing cap 16 can be made directly in a single body.

The gripping handwheel 15 and the closing cap 16 are understood to be directly made in a single body when they are integrated in a fixed manner, for example when they are made in a single mold, or attached by means of welding or gluing, or other modes that do not allow them to be separated without them breaking.

The gripping handwheel 15 and the closing cap 16 are understood to be a single body by stable association when they are separated and are joined together, for example at the time of use, so as to form a single body.

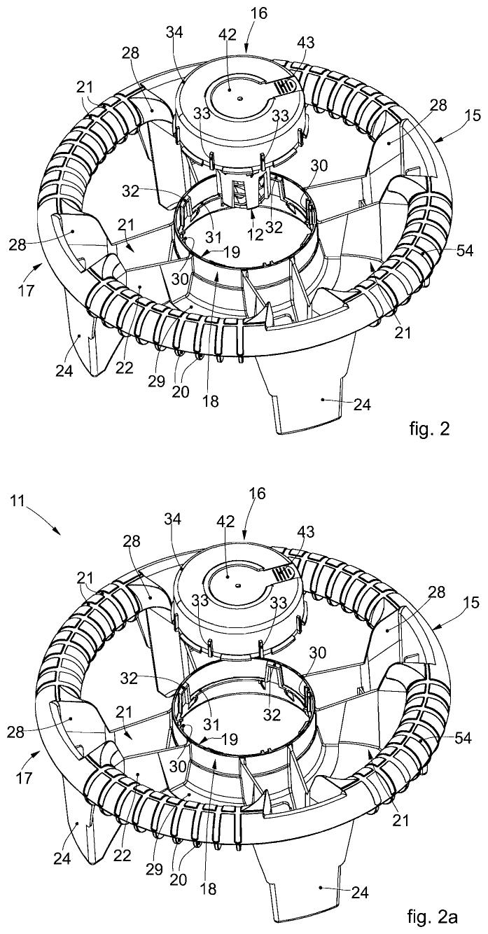

In an embodiment shown in FIGS. 2 and 2a, in which the gripping handwheel 15 and the closing cap 16 are in stable association, the gripping handwheel 15 and the closing cap 16 comprise respective coupling and guiding members 30, 31, 32, 33, 34 configured to allow the reciprocal stable association, without play and so that they move together, during use, during the union with the drum 13.

Such a condition is often necessary due to variations of the characteristics of the closing caps 16, having to possibly also provide to use specialized intermediate adaptor means between the gripping handwheel 15 and the various closing caps 16.

The closing cap 16 is suitable, during use, to selectively close the entrance 25 of the drum 13 in a stable and hermetic manner, allowing the tapping, in synergy with the valve unit 12.

The closing cap 16 can couple directly and in a stable manner with the valve unit 12, as shown in FIG. 2.

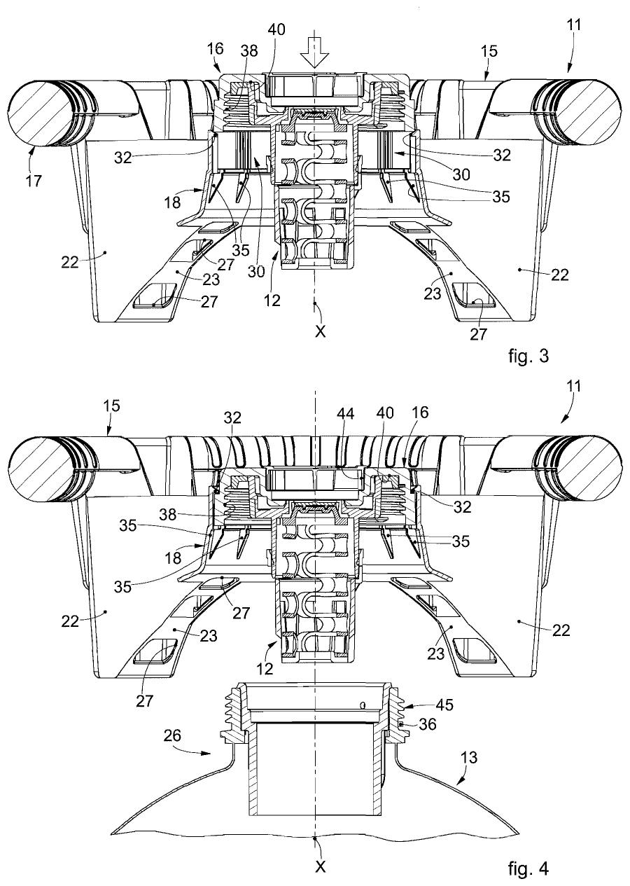

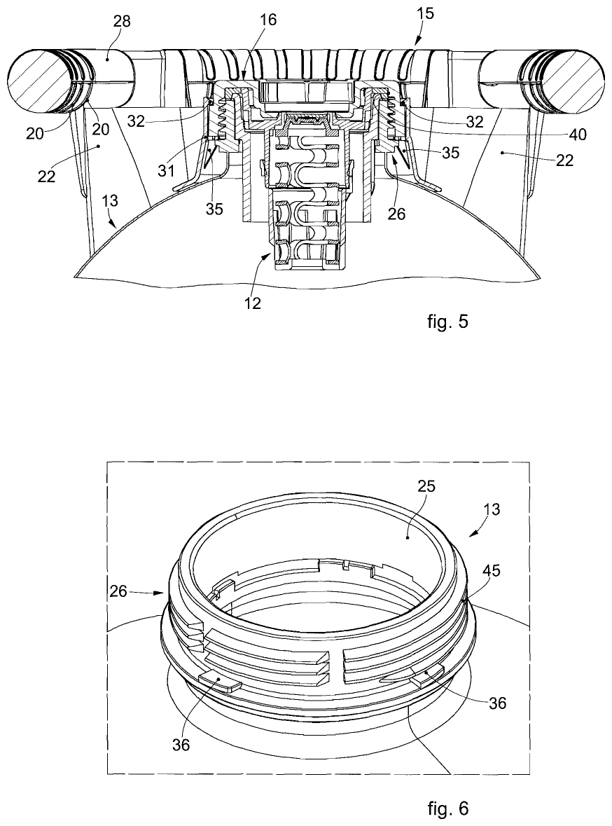

In the example shown in FIGS. 3-5 and 8, the valve unit 12 is inserted in the entrance 25, connected to the closing cap 16.

The closing cap 16 can comprise, or cooperate with, elements to adapt to the valve unit 12, not shown in the drawings.

The valve unit 12 shown, according to possible embodiments of the invention, is in itself known and already patented, and allows the flow of the liquid and gas under pressure in the container 10.

The gripping handwheel 15 can be suitable to handle and move the container 10.

The gripping and closing device 11 therefore performs a double function, both of closing the drum 13, guaranteeing hygiene and preservation of the content, and also of gripping element in order to facilitate the movement of the container 10 by a user.

According to some embodiments, the gripping handwheel 15 can comprise gripping handle means 17, externally, and attachment means 18, internally.

According to some embodiments, the attachment means 18 can internally define an insertion and clamping seating 19 for the closing cap 16 or the intermediate adaptor means.

In some embodiments, the suitable coupling and guiding members 30, 31, 32 can be provided in the attachment means 18 of the gripping handwheel 15. In this way, the attachment means 18 can be suitable to allow the stable association of the gripping handwheel 15 with the specific and suitable closing cap 16.

According to some embodiments, the coupling and guiding members 30, 31, 32 can be able to couple with the mating coupling members 33, 34 present in the closing cap 16.

According to possible solutions, the coupling members comprise guiding elements 30, configured to define a correct positioning of the closing cap 16 during its insertion.

According to some embodiments, the coupling members comprise abutment elements 31 against which the edge of the closing cap 16 can be positioned in the assembled configuration of the gripping and closing device 11.

According to some embodiments, the coupling members comprise fastening elements 32 suitable to clamp the closing cap 16 into position and which cooperate with the possible coupling members 34 positioned on the closing cap 16.

For example, the fastening elements 32 can be configured so as to have an inclined shape, acting as a lead-in in order to facilitate the insertion and stable positioning of the closing cap 16 in the desired position in the attachment means 18.

According to some embodiments, the attachment means 18 can comprise a collar 29 at the lower part, having a shape mating with the profile of the drum 13, on which it is positioned resting during use.

The collar 29 can therefore contribute to form a surface to support and distribute the weight on the drum 13.

In some embodiments, the gripping handle means 17 are suitable to be gripped by a user in order to move the container 10.

The gripping handle means 17 advantageously have an annular shape and can be disposed coaxially to the attachment means 18 with respect to a central axis X of the drum 13.

In some embodiments, the gripping handle means 17 can also have partly hollow sections, so as to lighten the gripping handwheel 15. For example, a shape with a semicircular and hollow section can be provided in the lower part.

According to some embodiments, the gripping handle means 17 advantageously have, at least on part of the radial profile, gripping elements 54 suitable to facilitate gripping in order to move the container 10 without causing damage to the user's hands. For example, the gripping elements 54 can be grooves, knurls, hollows, or rough surfaces or suchlike.

According to possible variants, the gripping handle means 17 can comprise strengthening elements 20, located on the lower part, for example ribs, which can have a double function of contributing to the grip and of increasing the mechanical strength of the gripping handwheel 15.

The strengthening elements 20 can have a substantially radial development with respect to the central axis X.

According to some embodiments, the gripping handwheel 15 can have connection elements 21 configured to connect the attachment means 18 to the gripping handle means 17.

The connection elements 21 can be for example angularly offset around the central axis X.

The connection elements 21 can for example extend in a radial or sub-radial direction with respect to the central axis X.

In a variant not shown, the connection elements 21 can connect the gripping handle means 17 to the closing cap 16 in a single body.

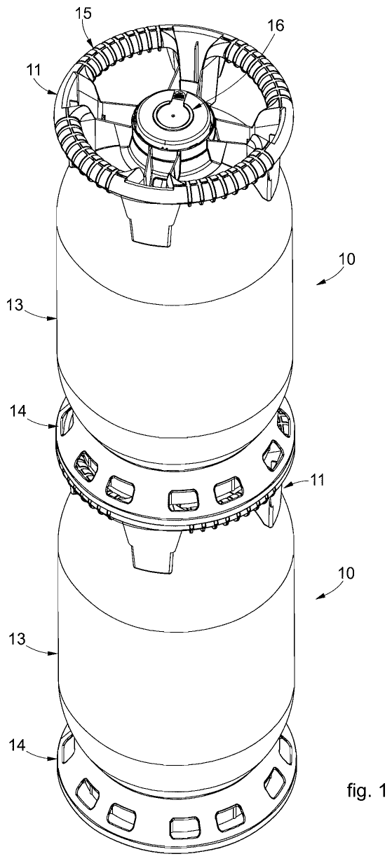

By way of example, FIGS. 1 and 2 show four connection elements 21 offset by 90° with respect to each other, but the number of said elements can also be lower or higher and have a positioning angle that can be, or not be, constant.

By way of example, the connection elements 21 can have a box-like structure and comprise two lateral walls 22 that extend facing each other, and one or more intermediate walls 23 that join the lateral walls 22 together.

In some embodiments, the connection elements 21 can also comprise external walls 24 which transversely join the lateral walls 22 on the opposite side to the attachment means 18 and which can be, or not be, joined to the intermediate walls 23.

According to possible solutions, the connection elements 21 can have the upper part free and at least the lower part with through apertures 27.

In particular, one or more of either the intermediate walls 23 and/or the lateral walls 22 and/or the external walls 24 can have apertures 27 suitable to lighten the gripping and closing device 11 and to allow possible liquids to exit, for example rain or liquids coming out of other containers which enter the gripping and closing device.

According to possible variants, however, it can also be provided that the walls as above are made solid, or also that the gripping handwheel 15 as a whole is made in solid form.

Advantageously, the lateral walls 22 and/or the intermediate walls 23 and/or the external walls 24 can cooperate in order to increase the strength of the connection elements 21 while at the same time maintaining their lightness, and to allow a good distribution of the loads in supporting the weight of the stacked containers 10.

According to some embodiments, the connection elements 21 can be shaped so as to be coherent with the upper profile of the drum 13, so as to be associated resting with extended, or not extended, parts of the external surface of the drum 13 and distribute the loads in a uniform manner around the central axis X.

The gripping and closing device 11 can therefore be suitable to increase the strength of the whole and to allow the containers 10 filled with liquids to be stacked on top of each other.

In some embodiments, the gripping handle means 17 can comprise connection structures 28 configured to connect the gripping handle means 17 and the connection elements 21 together, and be suitable to increase the strength of the gripping and closing device 11.

According to some embodiments, the closing cap 16 is provided on the lower part with a compartment 40 suitable to house and cooperate with the valve unit 12 of a suitable type.

According to some embodiments, the closing cap 16 comprises on the upper part a cavity 44 that can be equipped to anchor delivery means (not shown in the drawings) stably and without leakages, for example by means of attachment zones, such as threadings or bayonet-type intakes.

In particular, the cavity 44 can be shaped so as to be compatible with the various liquid delivery means available on the market.

The closing cap 16 can be provided with fastening means 38 suitable to cooperate with fastening means 45 in the neck portion 26 of the drum 13.

According to some embodiments, the fastening means 38, 45 can comprise respective threaded portions suitable to be screwed to each other.

Alternatively, the fastening means 38, 45 can be conformed in order to define a coupling of the bayonet or snap-in type.

In some embodiments, the closing cap 16 can be compatible with intermediate adaptor means, not shown in the drawings, specialized for the various closing caps, such intermediate means being suitable to stabilize the closing cap 16 with the gripping handwheel 15 by association, adapting them to each other.

According to a variant not shown which provides that the gripping handwheel 15 and the closing cap 16 are made in a single body, the connection elements 21 are connected to the closing cap 16.

The closing cap 16 can also comprise a safety lid 42 configured to hermetically close the cavity 44 at the upper part, protecting it from dirt and impurities in order to safeguard the hygiene of the container 10 and its contents.

The safety lid 42 can be removed when using the container 10 in order to allow access to the cavity 44 and to install the delivery means. The safety lid 42 has a gripping tab 43 to remove the safety lid 42.

According to some embodiments, the upper part of the gripping handle means 17 of the gripping handwheel 15 can be positioned at a greater height than the upper edge of the closing cap 16.

According to some embodiments, the connection elements 21 can have, in correspondence with their outermost peripheral portion, a height greater than or equal to the longitudinal extension of the valve unit 12 inserted, during use, in the container 10.

Advantageously, the gripping and closing device 11 can thus act as a protection for the closing cap 16 and for the valve unit 12, thus making the container 10 more resistant to stresses, for example bending stresses, which could bear on the valve unit 12, damaging or weakening it.

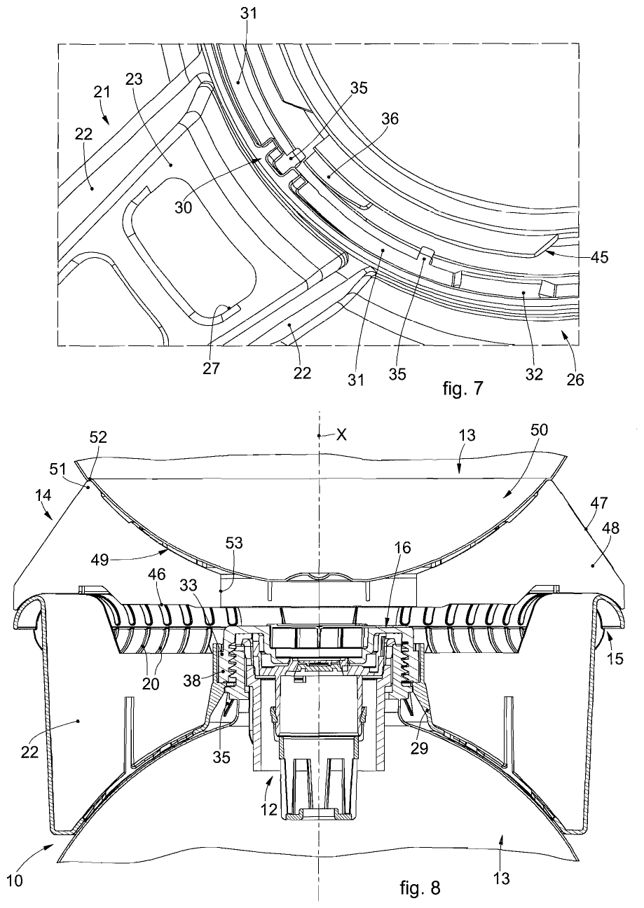

According to some embodiments, for example described with reference to FIG. 6 and FIG. 7, the gripping and closing device 11 comprises interference members 35 configured to cooperate with mating anti-tampering elements 36 present in a zone consistent with, or in proximity to, the neck portion 26 of the drum 13.

According to some embodiments, the interference members 35 can be provided on the attachment means 18.

According to a variant not shown, the interference members 35 can be provided on the closing cap 16 which is made in a single body with the gripping handwheel 15.

The interference members 35 advantageously operate with the anti-tampering elements 36, allowing to close the drum 13 correctly and clamping the gripping and closing device 11 in a position of non-return, since they are for example able to break and/or break the interference members 35 if the container 10 is reopened, indicating an attempt at tampering.

According to some embodiments, the gripping and closing device 11 can be made entirely of a single polymeric material, advantageously recyclable.

Embodiments described here also concern the bottom element 14 for the container 10, configured to support the drum 13 in a stable positioning, keeping it in a vertical direction.

Embodiments described here, with reference to FIG. 1 and FIG. 8, also concern a combination of the gripping and closing device 11 with the bottom element 14 possibly suitable to stack two or more containers 10 on top of each other.

In particular, the bottom element 14 can have a bottom base 46 with a shape, advantageously though not necessarily, at least partly mating with the upper surface of the gripping and closing device 11, achieving a same-shape coupling with it.

In this way, the bottom element 14 and the gripping and closing device 11 can be reciprocally stacked in a stable manner According to some embodiments, the bottom element 14 comprises a circular wall 47 and support walls 48.

According to some embodiments, advantageously the bottom element 14 also comprises gripping means for handling.

The support walls 48 extend in a radial direction with respect to the central axis X.

According to some embodiments, the lower edges of the support walls 48 and of the circular wall 47 lie on the same plane in order to guarantee a stable support surface of the bottom element 14.

According to further embodiments, the bottom element 14 has a concave seating 49 at the upper part, configured to house a bottom portion 50 of the drum 13.

According to some embodiments and as described in FIG. 8, the concave seating 49 can be delimited by positioning elements 51.

According to some embodiments, the positioning elements 51 can be configured to rest on mating positioning elements 52 of the bottom portion 50 of the drum 13.

In this way, an alignment of the container 10 with its own central axis X along a vertical axis is guaranteed, the containers 10 can be easily and safely stacked and, moreover, it is possible to stack the containers 10 on top of each other without using separator elements.

In some embodiments, the bottom base 46 can have a cavity 53 in correspondence with the closing cap 16, so as to rest only on the gripping handwheel 15 and not on the closing cap 16.

In this way, the bottom element 14 can be suitable to allow, together with the gripping handwheel 15, to use closing caps 16 with different characteristics and adaptable to different liquid delivery means.

Advantageously, the possibility of using the same bottom element 14 with gripping and closing devices 11 which have closing caps 16 of different thicknesses can allow to reduce the number of models of bottom element 14, thus reducing both production costs, and also storage and management costs.

In some embodiments, the components of the container 10 are advantageously made of the same recyclable polymeric material, allowing to recycle the container 10 as a whole and therefore simplifying its delivery, storage, transport and use for recycling.

Embodiments described here, and with reference to FIGS. 3, 4, 5, concern a method to assemble a gripping and closing device 11 in which a gripping handwheel 15 and a closing cap 16 are configured to obtain the reciprocal stable association.

The method to assemble the gripping and closing device 11 can comprise the following steps:

positioning the closing cap 16, comprising coupling members 33, 34, in relation to the gripping handwheel 15 which is provided, directly or by means of intermediate adaptor means, with an insertion and clamping seating 19 and with coupling and guiding members 30, 31, 32;

applying an axial force acting on the closing cap 16 and the gripping handwheel 15, by inserting the closing cap 16 in the insertion and clamping seating 19 and stabilizing the gripping handwheel 15 to the closing cap 16 by association.

Embodiments described here also concern a method to assemble a container 10, which can provide to make available a gripping and closing device 11 in which the gripping handwheel 15 and the closing cap 16 are operatively conformed substantially in a single body, obtained directly or by stable association, and integrate the gripping and closing device 11 with a neck portion 26 of the drum 13.

For example, in order to integrate the gripping and closing device 11 and the container 10 with each other, it can be provided to screw the gripping and closing device 11 to the neck portion 26 by means of respective fastening means 38, 45.

According to some embodiments, the method to assemble a container 10 provides, before integrating the gripping and closing device 11 with the drum 13, to stably couple the valve unit 12 with the closing cap 16.

According to other embodiments, the method to assemble a container 10 provides to insert the valve unit inside the neck portion 26 of the drum 13, in the entrance 25, resting on an upper edge thereof, and subsequently integrate the gripping and closing device 11 with the drum 13.

According to some embodiments, the method can provide to integrate the gripping and closing device 11 with the neck portion 26, until interference members 35, present on the gripping and closing device 11, are positioned in abutment on mating anti-tampering elements 36, provided in the neck portion 26, so as to clamp the gripping and closing device 11 in a position of non-return.

Advantageously, if a user tries to remove the gripping and closing device 11 from the container 10, the anti-tampering elements 36 against which the interference members 35 abut stop the gripping and closing device 11 in the integral position.

In the event the gripping and closing device 11 is removed from the container 10, the interference members 35 and/or the anti-tampering elements 36 can break, providing a visual indication of the tampering.

According to further embodiments, the method to assemble the container 10 can provide to associate, in a stable or removable manner, in correspondence with a bottom portion 50 of a drum 13, a bottom element 14 suitable to support it in the vertical direction.

It is clear that modifications and/or additions of parts may be made to the gripping and closing device 11, to the container 10 and to the methods to assemble the gripping and closing device 11 and the container 10 as described heretofore, without departing from the field and scope of the present invention.

It is also clear that, although the present invention has been described with reference to some specific examples, a person of skill in the art shall certainly be able to achieve many other equivalent forms of gripping and closing device 11 and container 10, having the characteristics as set forth in the claims and hence all coming within the field of protection defined thereby.

1. Gripping and closing device for a keg-type container for liquids, said gripping and closing device comprising a closing and tapping cap and a gripping handwheel suitable to handle and move the container, said container comprising a drum containing a bag and being able to cooperate with said closing cap, said closing cap being suitable to selectively close an entrance of the container allowing the tapping, said gripping and closing device being characterized in that said gripping handwheel and said closing cap in the operative condition are substantially conformed in a single body, obtained directly or by stable association.

2. Gripping and closing device as in claim 1, characterized in that said gripping handwheel comprises gripping handle means, an upper part of said gripping handle means being at a greater height than the upper edge of said closing cap.

3. Gripping and closing device as in claim 1, characterized in that said gripping handwheel comprises connection elements which are coherent with the upper profile of the drum, generating a plurality of support zones of said gripping and closing device on the drum.

4. Gripping and closing device as in claim 3, characterized in that said connection elements extend in a radial or sub-radial direction with respect to the central axis of the drum.

5. Gripping and closing device as in claim 3, characterized in that the upper part of the connection elements is free and at least the lower part has apertures.

6. Gripping and closing device as in claim 3, characterized in that it has connection structures between the gripping handle means and the connection elements.

7. Gripping and closing device as in claim 2, characterized in that the gripping handle means have gripping elements at least on part of the radial profile.

8. Gripping and closing device as in claim 2, characterized in that the gripping handle means have partly hollow sections with substantially radial strengthening elements located on the lower part.

9. Gripping and closing device as in claim 1, characterized in that said gripping and closing device comprises interference members, configured to cooperate with mating anti-tampering elements present in a zone in association with, or in proximity to, a neck portion of said drum.

10. Gripping and closing device as in claim 1, characterized in that said gripping handwheel comprises attachment means, defining an insertion and clamping seating for said closing cap, directly or with intermediate adaptor means.

11. Gripping and closing device as in claims from 1, characterized in that said gripping handwheel and said closing cap are made in a single body.

12. Combination of a gripping and closing device as in any claim from 1 and of a bottom element suitable to support the drum in a vertical direction, characterized in that said bottom element) has a bottom base with a shape at least partly mating with the upper surface of said gripping and closing device so that the gripping and closing device and the bottom element can be reciprocally stacked together in a stable manner by means of same shape coupling, and in that said bottom element advantageously has gripping means for handling.

13. Container for liquids comprising a drum, a valve unit, a gripping and closing device as in claim from 1 and possibly a bottom element.

14. Method to assemble a gripping and closing device, in which a gripping handwheel and a closing cap are configured to obtain a reciprocal stable association, characterized in that said method comprises:
positioning the closing cap, comprising coupling members, in relation to the gripping handwheel, provided, directly or by intermediate adaptor means, with an insertion and clamping seating and with coupling and guiding members;
applying an axial force acting on said closing cap and said gripping handwheel, inserting said closing cap in said insertion and clamping seating and stabilizing by association said gripping handwheel with said closing cap.

15. Method to assemble a container as in claim 14, characterized in that said method provides to make available said gripping and closing device with said gripping handwheel and said closing cap operatively conformed substantially in a single body, obtained directly or by stable association, and integrate said gripping and closing device with a neck portion of said drum.

16. Method to assemble a container as in claim 15, characterized in that before integrating said gripping and closing device with said drum it provides to stably couple said valve unit with said closing cap.

17. Method to assemble a container as in claim 15, characterized in that it provides to integrate said gripping and closing device with said neck portion until interference members present on said gripping and closing device are positioned in abutment on mating anti-tampering elements provided in the neck portion, clamping the gripping and closing device in a position of non-return.

18. Method as in claim 14, characterized in that said method provides to associate with the drum, in a stable or removable manner, a bottom element suitable to support it in the vertical direction.
